(19) United States
(12) Patent Application Publication
(10) Pub. No.: US 2023/0116125 A1
(43) Pub. Date: Apr. 13, 2023

(54) METHOD AND SYSTEM FOR SMART ASSISTANT VOICE COMMAND REQUESTOR AUTHENTICATION

(71) Applicant: ARRIS ENTERPRISES LLC, Suwanee, GA (US)

(72) Inventors: Albert F. ELCOCK, West Chester, PA (US); Christopher S. DELSORDO, Souderton, PA (US); Christopher Robert BOYD, Chalfont, PA (US)

(21) Appl. No.: 17/952,373

(22) Filed: Sep. 26, 2022

Related U.S. Application Data
(60) Provisional application No. 63/253,780, filed on Oct. 8, 2021.

(51) Int. Cl. G10L 17/22; G06V 40/16; G06V 40/12; G10L 17/04; H04N 21/422; H04N 21/4415; G16Y 30/10; G16Y 40/30

(52) U.S. Cl. CPC G10L 17/22; G06V 40/172; G06V 40/1365; G10L 17/04; H04N 21/42203; H04N 21/4415; G16Y 30/10; G16Y 40/30

(57) ABSTRACT

A method, a system, and a non-transitory computer readable medium are disclosed for controlling Internet of Thing (IoT) devices using voice command requestor authentication. The method includes receiving, on a smart assistant device, a voice command from a first user; identifying, on the smart assistant device, the first user from the voice command; determining, on the smart assistant device, an authentication status of the first user to a perform one or more requests to one or more IoT devices based on the identity of the first user; and sending, from the smart assistant device, one or more instructions to the one or more IoT devices when the first user has been authorized to execute a function of the one or more IoT devices.

### TECHNICAL FIELD

The present disclosure generally relates to a method and system for smart assistant voice command requestor authentication, and more particularly, a method for controlling Internet of Things (IoT) devices using voice command requestor authentication.

### BACKGROUND

Smart assistant technology is exploding and will become the expected mode of control for many devices. It would be desirable for the smart assistant device to allow specific voice commands to be executed based on the requestor of the command.

### SUMMARY

In accordance with exemplary embodiments, it would be desirable to have a method and system, which can configure smart assistant devices in the home and/or workplace with voice control smart assistant technology for voice controllable IoT devices such as controlling security systems or configuring workplace systems. For examples, a smart assistant capable device might be configured to be able to identify the person who is issuing the voice control command.

In accordance with an aspect, a method is disclosed for controlling Internet of Things (IoT) devices using voice command requestor authentication, the method comprising: receiving, on a smart assistant device, a voice command from a first user; identifying, on the smart assistant device, the first user from the voice command; determining, on the smart assistant device, an authentication status of the first user to a perform one or more requests to one or more Internet of Things (IoT) devices based on the identity of the first user; and sending, from the smart assistant device, one or more instructions to the one or more Internet of IoT devices when the first user has been authorized to execute a function of the one or more IoT devices.

In accordance with another aspect, a smart assistant device is disclosed, the smart assistant comprising: a memory; and a processor configured to: receive a voice command from a first user; identify the first user from the voice command; determine an authentication status of the first user to a perform one or more requests to one or more Internet of Things (IoT) devices based on the identity of the first user; and send one or more instructions to the one or more IoT devices when the first user has been authorized to execute a function of the one or more IoT devices.

In accordance with an aspect, a non-transitory computer readable medium storing computer readable program code that, when executed by a processor, causes the processor to control Internet of Things (IoT) devices using voice command requestor authentication is disclosed, the program code comprising instructions for: receiving, on a smart assistant device, a voice command from a first user; identifying, on the smart assistant device, the first user from the voice command; determining, on the smart assistant device, an authentication status of the first user to a perform one or more requests to one or more IoT devices based on the identity of the first user; and sending, from the smart assistant device, one or more instructions to the one or more IoT devices when the first user has been authorized to execute a function of the one or more IoT devices.

### BRIEF DESCRIPTION OF THE DRAWINGS

FIG. 1 is an illustration of an exemplary network environment for a system for smart assistant voice command requestor authentication in accordance with an exemplary embodiment.

FIG. 2 is an illustration of two conditional access requests made to change the temperature of a thermostat in accordance with an exemplary embodiment.

FIG. 3 is an illustration of a configuration of graphical user interface (GUI) for conditional access for one or more users for controlling the temperature of a thermostat in accordance with an exemplary embodiment.

FIGS. 4A and 4B are illustrations of allowing an unauthorized person access for controlling the temperature of a thermostat when a device belonging to authorized person is detected in proximity to a smart assistant device in accordance with an exemplary embodiment.

FIGS. 5A and 5B are illustrations of a user requesting confirmation via voice print identification when a facial recognition device has failed to detect an authorized person in proximity to a smart assistance device in accordance with an exemplary embodiment.

FIGS. 6A and 6B are illustrations of allowing an unauthorized person access to change the temperature of a thermostat upon receipt of confirmation from an authorized user in accordance with an exemplary embodiment.

FIG. 7 is a flowchart illustrating a method for smart assistant voice command requestor authentication in accordance with an exemplary embodiment.

FIG. 8 is an exemplary hardware architecture for an embodiment of a communication device or smart assistance device.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

### System for Smart Assistant Voice Command Requestor Authentication

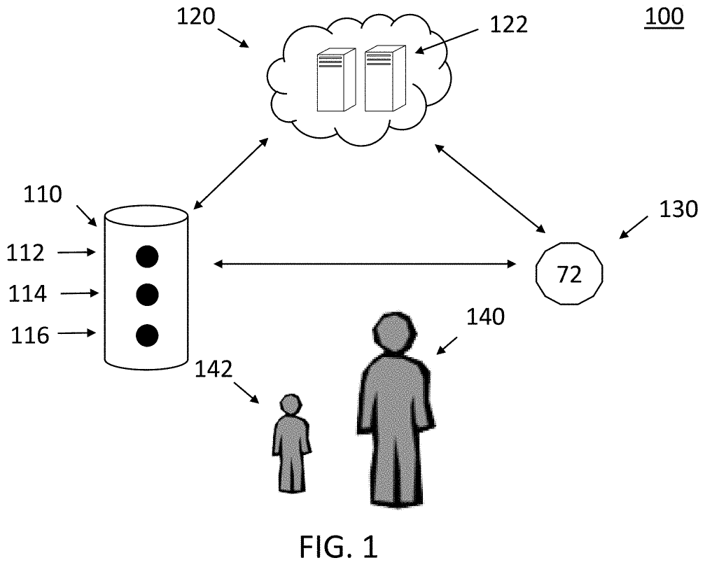

FIG. 1 is a block diagram illustrating an example network environment 100 for smart assistant voice command requestor authentication in accordance with an exemplary embodiment. In embodiments, a smart assistance device 110, a smart assistant service 120, and an IoT device 130 are disclosed. In accordance with an exemplary embodiment, the smart assistant device 110 can be, for example, a set-top box (STB), an Amazon Echo with virtual assistant artificial intelligent (AI) technology, for example, Amazon Alexa, a Google Nest or a Google Home, a device with Apple's Siri, or any intelligent virtual assistant or intelligent personal assistant device. The smart assistant device 110 may communicate with the smart assistant service 120 and/or the IoT device 130 over a local network (for example, a local area network (LAN), a wireless local area network (WLAN), a personal area network (PAN), etc.) and/or wired, for example, a television. In accordance with an exemplary embodiment, the smart assistant service 120 may be a hosted on one or more cloud servers 122.

In accordance with an exemplary embodiment, the smart assistant device 110 may be a computing device configured to connect via a wireless network, for example, wireless network utilizing an IEEE 802.11 specification, including a smart phone, a smart TV, a computer, a mobile device, a tablet, or any other device operable to communicate wirelessly with the IoT device 130.

In accordance with an exemplary embodiment, the network 100 can include a plurality of users 140, 142, which can have access to the IoT device 130, which can be within a home, an office, a building, or located elsewhere.

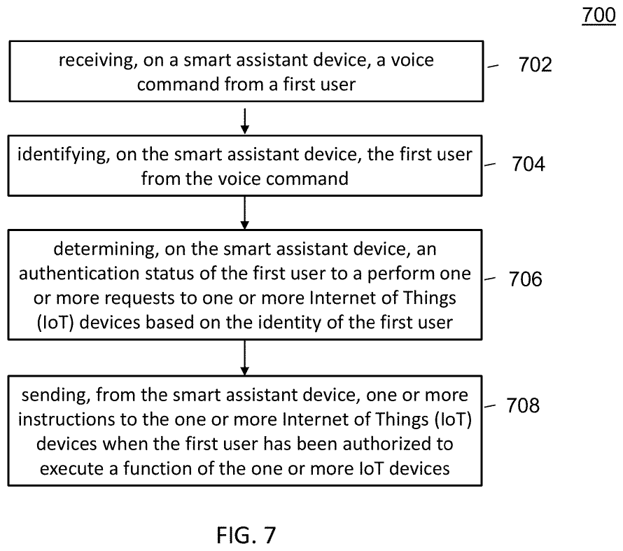

In accordance with an exemplary embodiment, it would be desirable to have a system and method for authenticating users 140, 142, via a smart assistant device 110 to provide access to one or more controls of an IoT device 130. In accordance with an embodiment, users (or voice command requestors) 140, 142 can be identified, for example, via voice print recognition, facial recognition, and/or fingerprint technologies. For example, a smart assistant device 110 that utilizes facial recognition can include a webcam device or camera 112 to perform the facial recognition configuration and verification steps. As shown in FIG. 1, the webcam device or camera 112 could be part of the smart assistant device 110 or a separate web cam or camera system 160 (FIG. 7) in communication with the smart assistant device 110. In addition, a smart assistant device 110 that utilizes, for example, voice print technology can include a microphone 114, and a user interface 116 capable of detecting, for example, a finger print of a user 140, 142. In accordance with an exemplary embodiment, the smart assistant device 110 can combine the two forms of identification for scenarios that would require, for example, a two-step authentication process. For example, other forms of identification of the voice control command requestor or user 140, 142, can include biometric authentication such as fingerprint detection, DNA detection, palm print detection, hand geometry detection, iris recognition, retina detection, face recognition and/or odor/scent detection.

In accordance with an exemplary embodiment, the method and system as disclosed herein would include the ability for the smart assistant device 110 to associate specific voice commands or groups of voice commands with the voice control command requestor or user 140, 142.

In accordance with another exemplary embodiment, the method and system as disclosed can also be used to associate a voice control requestor or user 140, 142, with voice control command locks. For example, voice control command locks can be a feature that allows the enabling or disabling of specific voice commands or a group of voice commands, for example, for security purposes. For example, voice commands that specifically include “security system” could have a voice command lock, which can be enabled and disabled by the owner (e.g., a first user 140) of the home so that his/her children (e.g., second user 142) do not have the capability to control the security system. For example, it would be desirable to have a voice command lock feature in the workplace environment where configuration of smart assistant devices 110 can be executed and/or performed, for example, by supervisors or others with a certain status rather than by every employee.

In accordance with an exemplary embodiment, the method and system can also be configured to sense the proximity of a known voice command requestor or user 140, which can allow users, for example, user 142 in the nearby vicinity to issue voice commands that are only allowed by a known voice command requestor, for example, user 140.

In accordance with an exemplary embodiment, the smart assistant device 110 can be configured to identify the voice control command requestor or user 140, 142, for example, using law enforcement technologies, which are able to identify a particular person (or user 140, 142) based visual and/or audio characteristics. For example, voice print technologies can be uses to record a person's voice for later identification of that person's voice. Facial recognition technologies can utilize visual recording of a person's face for later identification. Other techniques, for example, such as finger print technologies can also be used. In accordance with an exemplary embodiment, the smart assistant device 110 could be trained to identify the requestor using a voice control command. In addition, the method and systems as disclosed herein can include, for example, WiFi Doppler recognition, which can be used to detect the presence or absence of one or more users 140, 142.

For example, when voice print technology is chosen as one of the requestor identification methodologies, the method and system will require the user 140, 142, to interact with the smart assistant device 110 to initiate recording of voice command sequences that are related to the voice commands that only the user 140, 142 will be able to execute. In accordance with an exemplary embodiment, the recorded voice command sequences are received from one or more users 140, 142, each of the one or more users 140, 142 being authorized to execute the function of the one or more IoT devices 130, and which are associated with the recorded voice command sequence. The voice command sequence can be, for example, a subset of words, for example, two or more words spoken in a specific order that can be used in a voice command. Alternatively, the voice command sequence can be, for example, the entire voice command itself. During the user recognition configuration stage (or requestor recognition configuration stage), for example, the user 140, 142, can say and record a “security system” voice command sequence. The voice print would then be assigned/associated and tagged as a system voice command tag for the user, for example, a first user 140. The voice command tag can be stored and used, for example, in a smart assistant service, 120, for example, using a smart assistant cloud infrastructure smart routine processing. In accordance with an exemplary embodiment, for systems where command recognition is performed locally, the voice command tag can be stored, for example, locally on the smart screen device 110.

In accordance with an exemplary embodiment, the configuration of voice command requestor voice command sequences and voice command tag association is preferably performed first upon the registration of the one or more users 140, 142, with a smart assistant device 110. For example, in accordance with an exemplary embodiment, during the processing of a voice command from a user 140, 142, a determination can be made if the current voice command being processed includes a voice command sequence. If the voice command does not include a voice command sequence, the smart assistant device 110 will just execute the smart routine associated with the command. For example, a request for current weather conditions or a type of music. In accordance with an exemplary embodiment, the smart assistant device 110 can include a list of voice command tags and their associated voice command sequences and requestor identification data.

In accordance with an exemplary embodiment, when the voice command does include a voice command sequence, the voice print of the voice command is compared with the voice print associated in the voice command tag. If there is a match, then the smart routine is carried out, or alternatively, if there is not a match, an appropriate response can be issued that indicates the command is restricted for certain requestors. Alternatively, if there is no match, the smart assistant device 110 can take no action, for example.

In accordance with an exemplary embodiment, when a user 140, 142, includes a “security system” voice command sequence in the voice command of the user 140, 142, the smart assistant device 110 can recognize that “security system” is included, and the smart assistant device 110 can process the voice print of the first user 140 by comparing the voice print of the first user 140 with the voice print contained in security system voice command tag of the first user 140. In accordance with an exemplary embodiment, the smart assistant device 110 can determine that the voice command tag of the first user 140 has been spoken, and the smart assistant device 110 can provide instruction to execute the command by the smart assistant device 110 and/or alternatively, sending instructions to an IoT device 130, for example, a thermostat 132, to execute the instructions.

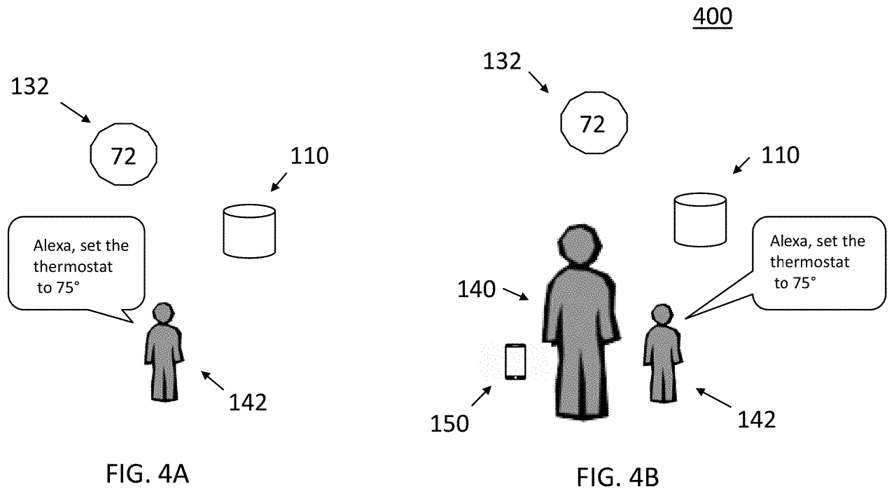

In accordance with an exemplary embodiment, the method and systems disclosed can also make use of exiting proximity detection solutions that sense the presence of an authorized voice command requestor nearby the smart assistant device 110 as the smart assistant device 110 recognizes voice command sequences from one or more user. For example, the smart assistant device 110 can executed an additional configuration step such as adding the MAC address of a mobile phone or smart device 150 (FIG. 4B) of the user or voice command requestor 140 as a means of detecting the presence of the user 140. Alternatively, one or more types of proximity detection can be performed, for example, via facial recognition of the presence of the user or voice command requestor 140 near and/or in the vicinity of the smart assistant device 110, for example, when a second user 140 speaks the voice control sequence commands. For example, in accordance with an exemplary embodiment, an additional configuration step can be executed in which proximity detection of the first user 140 can be enabled for a particular voice command sequence by a second user 142. For example, the proximity detection can include an enabling flag that is added to the voice control tag, which enhances the system voice command tag of the first user 140 by adding a proximity detection flag and when the first user 140 and the second user 142 are in the same room or vicinity in which the second user 142 issues a voice command to enable the security system. The smart assistant device 110 can use, for example, facial recognition to determine that the first user 140 is in relatively close proximity to the second user 142, which has issued the command such that the command issued by the second user 142 can be carried out.

In accordance with an exemplary embodiment, the method and system as disclosed can be implemented, for example, using smart assistant devices 110 that include one or more of Amazon Alexa Custom Skill or Google Custom Action technologies to carry out the smart routines. In accordance with an exemplary embodiment, the method and system as disclosed also can use custom skills that are created to control the security system to verify and confirm the voice command tags for voice command sequence and identification of the user or requestor 140, 142.

In accordance with an exemplary embodiment, the method and systems as disclosed can also provide voice command sequence history reporting. For example, if a user 140 has set up a voice command tag that only allows the user 140 to control a security system via voice control, the method and system can also provide historical information that indicates, for example, that the user 140 enabled the security system at certain time, for example, 11:30 μm. In addition, a voice command sequence history can also provide information, for example, if a non-authorized person or user 142 has attempted to disable the security system. Alternatively, the method and system can provide historical data on the voice command tags user by each on the one or more users 140, 142.

In accordance with an exemplary embodiment, the system and methods as disclosed can include various capabilities tied to voice command detection and authentication of the one or more users 140, 142. In addition, the method and system can allow the user 140, 142 to set up the user 140 as the only person to carry out a particular voice command sequence, or alternatively, to allow other users, for example, user 142 to carry out a particular voice command sequence.

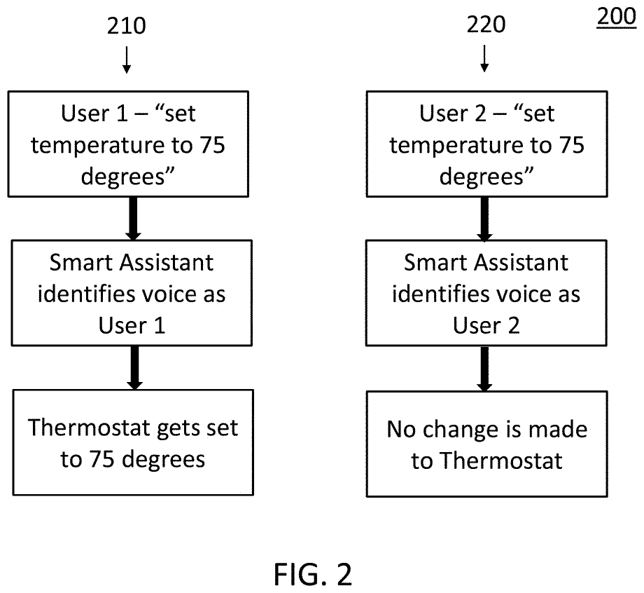

FIG. 2 is an illustration of two conditional access requests 200 made to change the temperature of a thermostat 132 in accordance with an exemplary embodiment. Setting of a thermostat is but one of many possibilities, as nearly any IoT devices may be commanded to respond in accordance with its capabilities using this disclosed method and system. In accordance with a first exemplary embodiment 210, a user (User 1) 140 can make a condition request, for example, “set temperature to 75 degrees”, which is received by the smart assistant device 110, and which can identify the voice of the first user 140 as User 1. As set forth, the first user 140 can be authorized to control the temperature of the thermostat 130, and the temperature of the thermostat 132 gets set to 75 degrees.

In accordance with a second exemplary embodiment 220, a second user (User 2) 142 can make a conditional request similar to that of the first user 140, for example, “set temperature to 75 degrees”, which is received by the smart assistant device 110. In the second exemplary embodiment 220, the smart assistant device 110 identifies the voice of the user 142 as User 2, who is not authorized to control the temperature of the thermostat 132, and the temperature of the thermostat 132 does not get set to 75 degrees. Accordingly, no change made to the temperature of the thermostat 132.

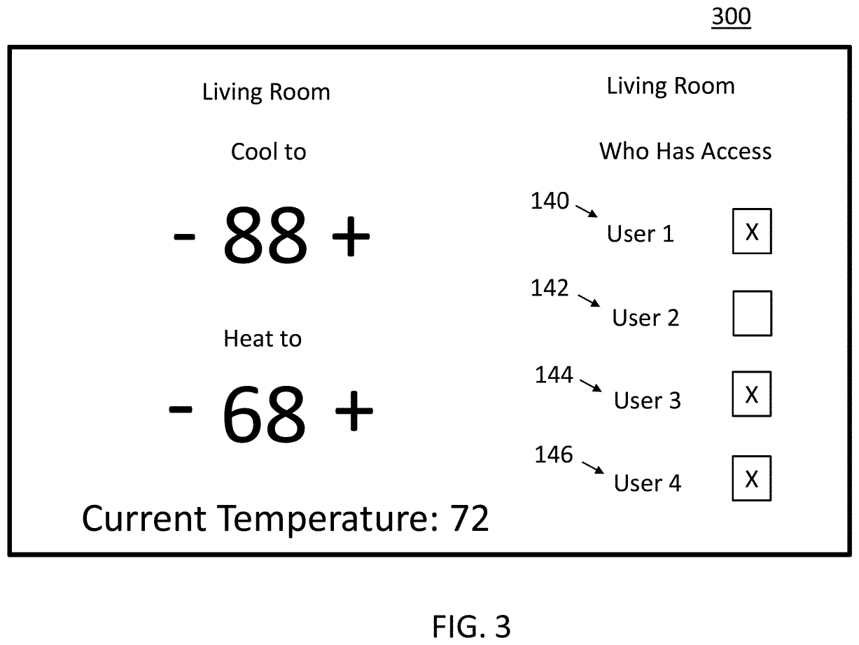

FIG. 3 is an illustration of a configuration 300, for example, a graphical user interface (GUI) for conditional access for one or more users 140, 142, 144, 146 for controlling a thermostat in accordance with an exemplary embodiment. As shown in FIG. 3, the configuration 300 can include a location, for example, the living room in which the temperature via the thermostat can be set, for example, “Cool to” plus or minus a range (e.g. currently set at 88 degrees), and a “Heat to” plus or minus range (e.g., current set 68 degrees) with a current temperature, for example, “Current Temperature: 72 degrees”. In accordance with an exemplary embodiment, one or more users 140, 142, 144, 146, can be given access to change the temperature via, for example, voice recognition and/or other biometric recognition technologies as disclosed herein. For example, users 140, 144, 146 (e.g., User 1, User 3, User 4) can be given access to change temperature of the thermostat 132. However, for example, as set forth above in FIG. 2, User 2 142 may not have access to change the temperature of the thermostat 132. In accordance with an exemplary embodiment, User 2 142 may not have access, for example, to change the temperature of the thermostat 132 because of the age of the user, or other conditions that an administrator, for example, a parent and/or guardian does not wish for the user 142 to have access to change the temperature of the thermostat 132 based on voice recognition or other biometric recognition technologies.

FIGS. 4A and 4B are illustrations 400 of allowing an unauthorized person (e.g., user 2) 142 access for controlling the temperature of a thermostat 132 when a device 150 belonging to authorized person (user 1) 140 is detected in proximity to a smart assistant device 110 in accordance with an exemplary embodiment. As shown in FIG. 4A, a smart assistant device 110, for example, a cloud-based smart assistant device 110 having technology such as Alexa can be used to control a thermostat 132. The user 142 may state, “Alexa, set the thermostat to 75°”. As shown in FIG. 4A, the user 142, however, may not have authorization or conditional access to make such a change, and without the presence, for example, of an authorized user, for example, user 1 140, the smart assistant device 110 will not change the temperature of the thermostat 142.

As shown in FIG. 4B, when the user 142 request that the temperature be changed to 75 degrees (e.g., “Alexa, set the thermostat to 75°), the smart assistant device 110 can detect the presence, for example, of a wireless device or smart phone 150 of an authorized user 140. Accordingly, based on the presence of the wireless device or smart phone 150 of the authorized user 140, the temperature of the thermostat 132 can be set as requested by user 142.

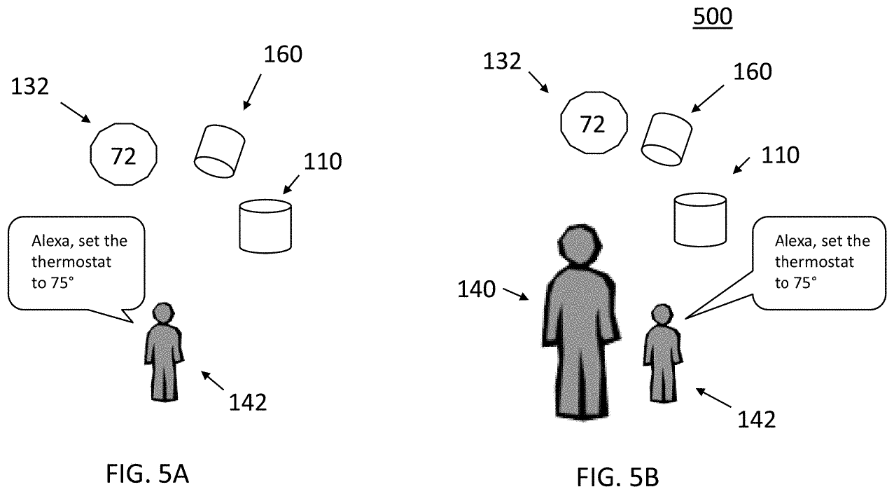

FIG. 5A is illustrations of a user 142 requesting confirmation via voice print identification 500 when a facial recognition device 160 has failed to detect an authorized person (e.g., user 142) in close proximity to a smart assistance device 110 in accordance with an exemplary embodiment. As shown in FIG. 5A, a user 142 may request a cloud-based smart assistant device 110 having virtual assistant artificial intelligence technology, such as Alexa, which can be used to control a thermostat 132. The user 142 may state, “Alexa, set the thermostat to 75°”. As shown in FIG. 5A, the user 142 may not have authorization or conditional access to make such a change, and without the presence, for example, of an authorized user, for example, user 1 140, which is recognized using the facial recognition device 160, the smart assistant device 110 will not change the temperature of the thermostat 142.

As shown in FIG. 5B, when the user 142 request that the temperature be changed to 75 degrees (e.g., “Alexa, set the thermostat to 75°), the smart assistant device 110 can detect the presence, for example, via a facial recognition device 160 of an authorized user (user 1) 140. Accordingly, based on the facial recognition of the authorized user 140, the temperature of the thermostat 132 can be set as requested by user 142.

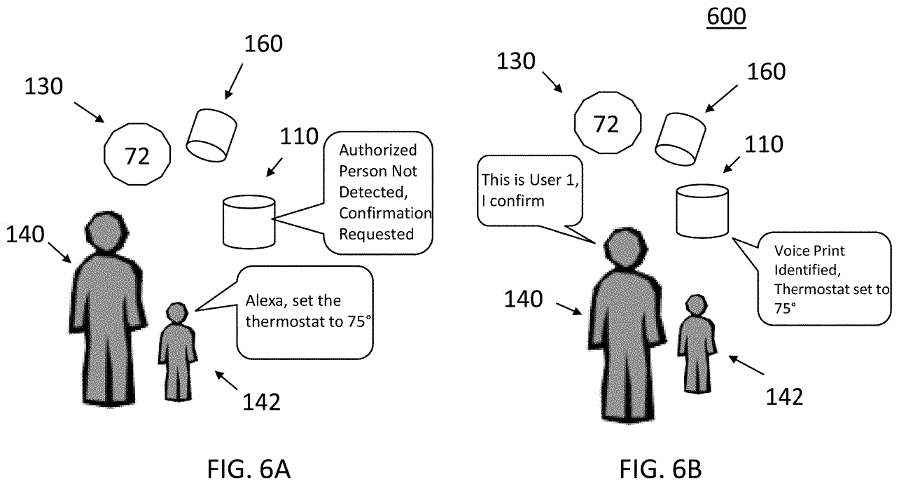

FIGS. 6A and 6B are illustrations of allowing an unauthorized person access 600 upon receipt of confirmation from an authorized user in accordance with an exemplary embodiment. As shown in FIG. 6A, the user 142 may state, “Alexa, set the thermostat to 75°”. As shown in FIG. 6A, the user 142 may not have authorization or conditional access to make such a change, and without the presence, for example, of an authorized user, for example, user 1 140, the smart assistant device 110 will not change the temperature of the thermostat 142. In this exemplary embodiment, the facial detection device 160 may not be able and/or fails to recognize the authorized user 142. For example, in response, the mart assistant device 110 can respond to the user 140, that an “authorized person not detected, confirmation requested”.

As shown in FIG. 6B, in response to the request of the smart assistant device 110 for confirmation, user 140 can respond with a voice print by stating “This is User 1, I confirm”, which the smart assistant device 110 can acknowledge the voice print of the authorized user 140 and respond by stating “Voice Print Identified, Thermostat set to 75°.” Accordingly, based on the presence of the voice print or voice recognition of the authorized user 140, the temperature of the thermostat 132 can be set as requested by user 142.

FIG. 7 is a flowchart illustrating a method for smart assistant voice command requestor authentication 700 for authenticating a user in accordance with an exemplary embodiment. As shown in FIG. 7, in step 702, a voice command from a first user 140 is received can be received on a smart assistant device 110. In step 704, the first user 140 from the voice command is identified on the smart assistant device 110. In step 706, an authentication status of the first user 140 to a perform one or more requests to one or more Internet of Things (IoT) devices 130 based on the identity of the first user 140 is determined on the smart assistant device. In step 708, one or more instructions to the one or more Internet of Things (IoT) devices 130 when the first user 140 has been authorized to execute a function of the one or more IoT devices 130 is sent from the smart assistant device 110.

In accordance with an aspect, the voice command can be a first authenticator, and the method can further include receiving, on the smart assistant device 110, for example, facial recognition data on the first user 140. The smart assistant device 110 can further identify the first user 140 from the facial recognition data and a second authenticator for the first user 140 can be determined based on the facial recognition data. The smart assistant device 110 can then send the one or more instructions to the one or more IoT devices 130 when the first authenticator and the second authenticator for the first user 140 has been determined.

In accordance with another aspect, the voice command can be a first authenticator, and the method can further include receiving, on the smart assistant device 110, fingerprint recognition data on the first user 140. The smart assistant device 110 can identify the first user 140 from the fingerprint recognition data and can send the one or more instructions to the one or more IoT devices 130 when the first authenticator and the second authenticator for the first user 140 has been determined.

In accordance with an aspect, the voice command can be one or more voice command sequences, and wherein the method further includes receiving, on the smart assistant device 110, the one or more voice command sequences from the first user 140; comparing, on the smart assistant device 110, the one or more voice command sequences from the first user to one or more voice command sequences in a database of voice command sequences; and determining, on the smart assistant device 110, the authentication status of the first user 140 based on the one or more voice command sequences compared to the one or more voice command sequences in the database of voice command sequences. For example, the one or more voice command sequences can be one or more words or phrases that are executable by the one or more IoT devices 130. In accordance with an exemplary embodiment, the method further includes requesting, by the smart assistant device 110, the first user 140 to record at least one of the one or more words or phrases that are executable by the one or more IoT devices 130, the first user being authorized to execute the function of the one or more IoT devices 130 associated with the one or more words or phrases; and receiving, by the smart assistant device 110, the at least one of the one or more words or phrases that executable by the one or more IoT devices 130 to train the smart assistant device 110.

In accordance with another aspect, the smart assistant device 110 can be a set-top box, the set-top box including one or more of a voice recognition application, a facial recognition application, and a fingerprint recognition application, and the one or more IoT devices 130 includes one or more of a security system, a temperature setting device, and a communication system.

In accordance with another aspect, the method can include receiving, on the smart assistant device 110, a voice command of a second user 142; determining, on the smart assistant device 110, that the voice command of the second user 142 is not authenticated to execute a function on one or more of the IoT devices based on an authentication status of the second user 142; receiving, on the smart assistant device 110, a proximity detection of the first user 140, the first user 140 being authenticated to executed the function on the one or more of the IoT devices 130 as requested by the second user 142; and sending, by the smart assistant device 110, instructions to the one or more of the IoT devices 130 to execute the voice command of the second user 142 based on the proximity detection of the first user 140. For example, the proximity detection is one or more of a voice command from the first user 140, facial recognition of the first user 140, fingerprint recognition of the first user 140, or a detection of a mobile device or smart device 150 of the first user 140. In addition, the method can include detecting, on the smart assistant device 110, an identifier of the mobile device or the smart device 150 that confirms the detection of the mobile device or smart device 150 of the first user 140 within a predefined proximity of the smart assistant device 110.

In accordance with an aspect, the method can include hosting, on the smart assistant device 110, a database of users that are authorized to execute one or more functions of the one or more IoT devices 130; and receiving, on the smart assistant device 110, one or more of a voice command, facial recognition data, and fingerprint data from a third user 144; determining, on the smart assistant device 110, an authentication status of the third user 144 based on one or more of the voice command, the facial recognition data, and the fingerprint data from the third user 144; and sending, from the smart assistant device 110, one or more instructions to the one or more Internet of Things (IoT) devices 130 when the second user has been authorized to execute a function on one or more of the IoT devices 130.

### Computer System Architecture

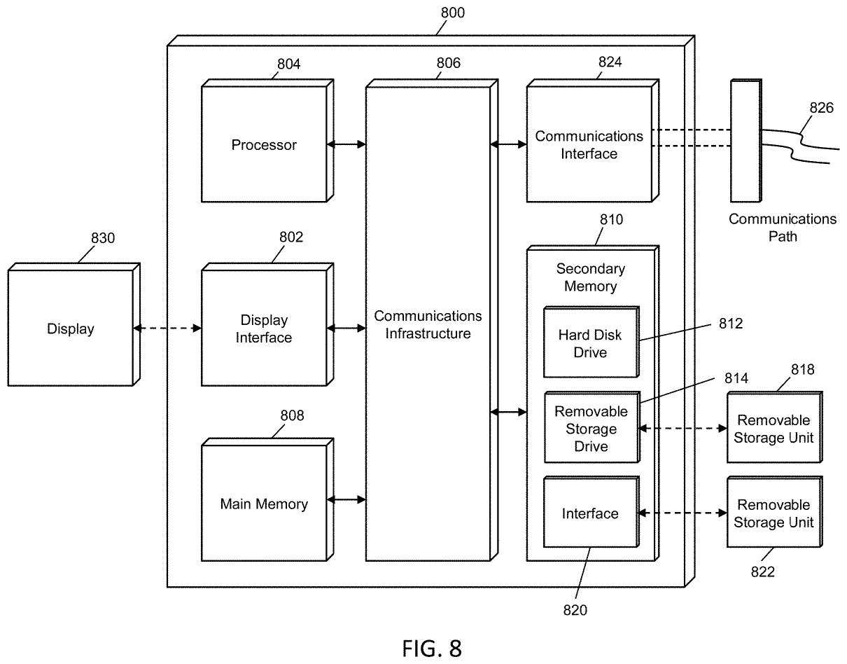

FIG. 8 illustrates a representative computer system 800 in which embodiments of the present disclosure, or portions thereof, may be implemented as computer-readable code executed on hardware. For example, the smart assistant device 110, the smart assistant service 120, one or more of the IoT devices 130, and corresponding one or more cloud servers 122 of FIGS. 1-7 may be implemented in whole or in part by a computer system 800 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this representative computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 804 may be processor device specifically configured to perform the functions discussed herein. The processor device 804 may be connected to a communications infrastructure 806, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 1-7, as discussed herein. Accordingly, such computer programs may represent controllers of the computer system 800. Where the present disclosure is implemented using software executed on hardware, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software executed on hardware, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, method for authenticating a user. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for controlling Internet of Things (IoT) devices using voice command requestor authentication, the method comprising:
receiving, on a smart assistant device, a voice command from a first user;
identifying, on the smart assistant device, the first user from the voice command;
determining, on the smart assistant device, an authentication status of the first user to a perform one or more requests to one or more IoT devices based on the identity of the first user; and
sending, from the smart assistant device, one or more instructions to the one or more IoT devices when the first user has been authorized to execute a function of the one or more IoT devices.

2. The method according to claim 1, wherein the voice command is a first authenticator, the method further comprising:
receiving, on the smart assistant device, facial recognition data on the first user;
identifying, on the smart assistant device, the first user from the facial recognition data;
determining, on the smart assistant device, a second authenticator for the first user based on the facial recognition data; and
sending, from the smart assistant device, the one or more instructions to the one or more IoT devices when the first authenticator and the second authenticator for the first user has been determined.

3. The method according to claim 1, wherein the voice command is a first authenticator, the method further comprising:
receiving, on the smart assistant device, fingerprint recognition data on the first user;
identifying, on the smart assistant device, the first user from the fingerprint recognition data; and
sending, from the smart assistant device, the one or more instructions to the one or more IoT devices when the first authenticator and the second authenticator for the first user has been determined.

4. The method according to claim 1, wherein the voice command is one or more voice command sequences, the method further comprising:
receiving, on the smart assistant device, the one or more voice command sequences from the first user;
comparing, on the smart assistant device, the one or more voice command sequences from the first user to one or more voice command sequences in a database of voice command sequences; and
determining, on the smart assistant device, the authentication status of the first user based on the one or more voice command sequences compared to the one or more voice command sequences in the database of voice command sequences.

5. The method according to claim 4, wherein the one or more voice command sequences is one or more words or phrases that are executable by the one or more IoT devices, the method further comprising:
requesting, by the smart assistant device, the first user to record at least one of the one or more words or phrases that are executable by the one or more IoT devices, the first user being authorized to execute the function of the one or more IoT devices associated with the one or more words or phrases; and
receiving, by the smart assistant device, the at least one of the one or more words or phrases that executable by the one or more IoT devices to train the smart assistant device.

6. The method according to claim 1, wherein the smart assistant device is a set-top box, the set-top box including one or more of a voice recognition application, a facial recognition application, and a fingerprint recognition application, and the one or more IoT devices includes one or more of a security system, a temperature setting device, and a communication system.

7. The method according to claim 1, further comprising:
receiving, on the smart assistant device, a voice command of a second user;
determining, on the smart assistant device, that the voice command of the second user is not authenticated to execute a function on one or more of the IoT devices based on an authentication status of the second user;
receiving, on the smart assistant device, a proximity detection of the first user, the first user being authenticated to executed the function on the one or more of the IoT devices as requested by the second user; and
sending, by the smart assistant device, instructions to the one or more of the IoT devices to execute the voice command of the second user based on the proximity detection of the first user.

8. The method according to claim 7, wherein the proximity detection is one or more of a voice command from the first user, facial recognition of the first user, fingerprint recognition of the first user, or a detection of a mobile device or smart device of the first user.

9. The method according to claim 8, further comprising:
detecting, on the smart assistant device, an identifier of the mobile device or the smart device that confirms the detection of the mobile device or smart device of the first user within a predefined proximity of the smart assistant device.

10. The method according to claim 1, further comprising:
hosting, on the smart assistant device, a database of users that are authorized to execute one or more functions of the one or more IoT devices;
receiving, on the smart assistant device, one or more of a voice command, facial recognition data, and fingerprint data from a third user;
determining, on the smart assistant device, an authentication status of the second user based on one or more of the voice command, the facial recognition data, and the fingerprint data from the third user; and
sending, from the smart assistant device, one or more instructions to the one or more IoT devices when the third user has been authorized to execute a function on more of the IoT devices.

11. A smart assistant device, the smart assistant comprising:
a memory; and
a processor configured to:
receive a voice command from a first user;
identify the first user from the voice command;
determine an authentication status of the first user to a perform one or more requests to one or more Internet of Things (IoT) devices based on the identity of the first user; and
send one or more instructions to the one or more IoT devices when the first user has been authorized to execute a function of the one or more IoT devices.

12. The system according to claim 11, wherein the voice command is a first authenticator, the processor further configured to:
receive facial recognition data on the first user;
identify the first user from the facial recognition data;
determine on the smart assistant device, a second authenticator for the first user based on the facial recognition data; and
send the one or more instructions to the one or more IoT devices when the first authenticator and the second authenticator for the first user has been determined.

13. The system according to claim 11, wherein the voice command is a first authenticator, the processor further configured to:
receive fingerprint recognition data on the first user;
identify the first user from the fingerprint recognition data; and
send the one or more instructions to the one or more IoT devices when the first authenticator and the second authenticator for the first user has been determined.

14. The system according to claim 11, wherein the voice command is one or more voice command sequences, the processor further configured to:
receive the one or more voice command sequences from the first user;
compare the one or more voice command sequences from the first user to one or more voice command sequences in a database of voice command sequences; and
determine the authentication status of the first user based on the one or more voice command sequences compared to the one or more voice command sequences in the database of voice command sequences.

15. The system according to claim 14, wherein the one or more voice command sequences is one or more words or phrases that are executable by the one or more IoT devices, the processor further configured to:
request the first user to record at least one of the one or more words or phrases that are executable by the one or more IoT devices, the first user being authorized to execute the function of the one or more IoT devices associated with the one or more words or phrases; and
receive the at least one of the one or more words or phrases that executable by the one or more IoT devices to train the smart assistant device.

16. A non-transitory computer readable medium storing computer readable program code that, when executed by a processor, causes the processor to control Internet of Thing (IoT) devices using voice command requestor authentication, the program code comprising instructions for:
receiving, on a smart assistant device, a voice command from a first user;
identifying, on the smart assistant device, the first user from the voice command;
determining, on the smart assistant device, an authentication status of the first user to a perform one or more requests to one or more IoT devices based on the identity of the first user; and
sending, from the smart assistant device, one or more instructions to the one or more IoT devices when the first user has been authorized to execute a function of the one or more IoT devices.

17. The non-transitory computer readable medium according to claim 16, wherein the voice command is a first authenticator, the instructions further comprising:
receiving, on the smart assistant device, facial recognition data on the first user;
identifying, on the smart assistant device, the first user from the facial recognition data;
determining, on the smart assistant device, a second authenticator for the first user based on the facial recognition data; and
sending, from the smart assistant device, the one or more instructions to the one or more IoT devices when the first authenticator and the second authenticator for the first user has been determined.

18. The non-transitory computer readable medium according to claim 16, wherein the voice command is a first authenticator, the instructions further comprising:
receiving, on the smart assistant device, fingerprint recognition data on the first user;
identifying, on the smart assistant device, the first user from the fingerprint recognition data; and
sending, from the smart assistant device, the one or more instructions to the one or more IoT devices when the first authenticator and the second authenticator for the first user has been determined.

19. The non-transitory computer readable medium according to claim 16, wherein the voice command is one or more voice command sequences, the instructions further comprising:
receiving, on the smart assistant device, the one or more voice command sequences from the first user;
comparing, on the smart assistant device, the one or more voice command sequences from the first user to one or more voice command sequences in a database of voice command sequences; and
determining, on the smart assistant device, the authentication status of the first user based on the one or more voice command sequences compared to the one or more voice command sequences in the database of voice command sequences.

20. The non-transitory computer readable medium according to claim 19, wherein the one or more voice command sequences is one or more words or phrases that are executable by the one or more IoT devices, the instructions further comprising:
requesting, by the smart assistant device, the first user to record at least one of the one or more words or phrases that are executable by the one or more IoT devices, the first user being authorized to execute the function of the one or more IoT devices associated with the one or more words or phrases; and
receiving, by the smart assistant device, the at least one of the one or more words or phrases that executable by the one or more IoT devices to train the smart assistant device.
